(19) United States
(12) Patent Application Publication
(10) Pub. No.: US 2014/0268250 A1
(43) Pub. Date: Sep. 18, 2014

(54) SYSTEMS AND METHODS FOR RECEIPT-BASED MOBILE IMAGE CAPTURE

(71) Applicant: MITEK SYSTEMS, INC., San Diego, CA (US)

(72) Inventors: Grigori Nepomniachtchi, San Diego, CA (US); Nikolay Kotovich, San Diego, CA (US)

(73) Assignee: MITEK SYSTEMS, INC., San Diego, CA (US)

(21) Appl. No.: 14/217,139

(22) Filed: Mar. 17, 2014

Related U.S. Application Data
(60) Provisional application No. 61/801,963, filed on Mar. 15, 2013.

(51) Int. Cl. G06K 9/00; H04N 1/00

(52) U.S. Cl. CPC G06K 9/00469; H04N 1/00307
USPC 358/462

(57) ABSTRACT

Systems and methods of capturing data from mobile images of receipts implemented are provided herein. One of the most important tasks behind the mobile receipt capture technology is understanding and utilizing category-specific rules in the form of known document sizes, relationships between different document fields, etc. For example, knowledge that many receipts have 3 inch widths helps to alter an image to restore the actual size of a receipt, which in turn improves a printing function and, most importantly, accuracy of content extraction such as optical character recognition.

### BACKGROUND

1. Field of the Invention

Various embodiments described herein relate generally to the field of image processing. More particularly, various embodiments are directed in one exemplary aspect to processing an image of a receipt captured by a mobile device, identifying text fields and extracting relevant content therefrom.

2. Related Art

Mobile phone adoption continues to escalate, including ever-growing smart phone adoption and tablet usage. Mobile imaging is a discipline where a consumer takes a picture of a document, and that document is processed, extracting and extending the data contained within it for selected purposes. The convenience of this technique is powerful and is currently driving a desire for this technology throughout Financial Services and other industries.

One document that consumers often encounter is a paper receipt for a purchase of goods or services. In addition to simply confirming a purchase, receipts are valuable for numerous reasons—returns or exchanges of merchandise or services, tracking of expenses and budgets, classifying tax-deductible items, verification of purchase for warranties, etc. Consumers therefore have numerous reasons to keep receipts and also organize receipts in the event they are needed. However, keeping track of receipts and organizing them properly is a cumbersome task. The consumer must firm remember where the receipt was placed when the purchase was made and keep track of it until they arrive home to then further sort through it. In the process, the receipt may be lost, ripped, faded or otherwise damaged to the point that it can no longer be read.

### SUMMARY

Systems and methods of capturing data from mobile images of receipts implemented are provided herein.

Other features and advantages should become apparent from the following description of the preferred embodiments, taken in conjunction with the accompanying drawings.

### BRIEF DESCRIPTION OF THE DRAWINGS

Various embodiments disclosed herein are described in detail with reference to the following figures. The drawings are provided for purposes of illustration only and merely depict typical or exemplary embodiments. These drawings are provided to facilitate the reader's understanding and shall not be considered limiting of the breadth, scope, or applicability of the embodiments. It should be noted that for clarity and ease of illustration these drawings are not necessarily made to scale.

FIG. 1 is an image of a receipt captured by a mobile device, according to embodiments.

FIGS. 2A and 2B are grayscale and bitonal image snippets, respectively, of the receipt after initial image processing is performed on the original image, according to embodiments.

FIG. 3 is a flow diagram of a method of processing an image of a receipt and extracting content, according to embodiments.

FIG. 4 is a flow diagram of a further method of processing the image of the receipt and extracting the content, according to embodiments.

FIG. 5A is a low contrast grayscale image snippet of the receipt, according to embodiments.

FIG. 5B is a high contrast grayscale image snippet of the receipt, according to embodiments, according to embodiments.

FIG. 6A is an image of a portion of the image of the mobile receipt which contains one or more amount fields, according to embodiments.

FIG. 6B is an image of a portion of the image of the mobile receipt which contains a date field, according to embodiments.

FIG. 6C is an image of a portion of the image of the mobile receipt which contains an address field, according to embodiments.

FIG. 7 is a diagram illustrating various fields in a receipt, in accordance with various embodiments.

FIG. 8 is one embodiment of a network upon which the methods described herein may be implemented, and FIG. 9 is an embodiment of a computer, processor and memory upon which a mobile device, server or other computing device may be implemented to carry out the methods described herein.

The various embodiments mentioned above are described in further detail with reference to the aforementioned figured and the following detailed description of exemplary embodiments.

### DETAILED DESCRIPTION

The embodiments described herein are related to systems and methods for capturing an image of a receipt on a mobile device such as a smartphone or tablet and then identifying and processing various information within the receipt. One of the most important tasks behind the mobile receipt capture technology described herein is understanding and utilizing category-specific rules in the form of known document sizes, relationships between different document fields, etc. For example, knowledge that many receipts have 3 inch widths helps to alter an image to restore the actual size of a receipt, which in turn improves a printing function and, most importantly, accuracy of content extraction such as optical character recognition.

FIG. 1 illustrates a mobile image of a receipt, which the system can process to generate an output grayscale snippet shown in FIG. 2A, as well as a bitonal image, as shown in FIG. 2B. The descriptions below describe what types of grayscale enhancements could be used for different types of receipts. Methods of processing mobile images to generate grayscale and bitonal images are covered in U.S. patent application Ser. No. 12/906,036 (the '036 Application), filed Oct. 15, 2010, the contents of which are incorporated herein by reference in their entirety.

Embodiments described herein focus on capturing the following fields: date, address and tendered amount. These fields persist on a majority of receipts and are important for an application that is designed to process mobile receipts and extract the content therein. Other fields can be identified using similar methods.

Whereas several important fields on receipts could be captured using dynamic capture technology, as set forth in the '036 Application discussed above. The method for capturing the tendered amount is specifically applicable to receipt. Further details are provided below with regard to capturing tendered amounts.

The systems and methods described herein combines category-specific image and data capture technology with a specific workflow which allows a user to store images of receipts, choose types of receipts, convert the currencies and automatically create expense reports, etc. The latter can be sent to the user's email account in multiple forms.

FIG. 3 is a flow diagram of one example method of processing an image of a receipt and extracting content in accordance with the embodiments described herein. In a first step 10, a mobile image of a receipt is obtained (such as the image in FIG. 1). User-supplied data may also be obtained as it relates to the receipt or information about the user's location, etc. from the mobile device that will help classify the receipt. In step 20, a preprocessing step is performed, including auto-framing, cropping, binarization and grayscale enhancements as described in the '036 application. The result of preprocessing is the creation of a bitonal snippet and grayscale snippet of the image of the receipt (step 30). In step 40, a preliminary data capture step is performed, as will be described in further detail below with regard to FIG. 4 and steps 80-130. In step 50, preliminary (“raw”) field results are generated as a result of the preliminary data capture process. Next, in step 60, post-processing is performed using a database to correlate names and addresses, business rules, etc. In step 70, final field data created by step 60 is displayed.

FIG. 4 is a flow diagram of a further example method of processing the image of the receipt and extracting the content, according to one embodiment. In step 10, the mobile image of a receipt (such as that illustrated in FIG. 1) is received. In step 20, the mobile preprocessing step, the image is preprocessed using processes such as auto-framing, cropping, binarization and grayscale enhancements. Grayscale and bitonal (1 bit per pixel) snippets created by preprocessing are then generated in step 30. Since the size of receipt is often unknown at this moment, the dimensions of the image can be corrected below. In step 40, a size identification process is performed to identify the size of the document in the image. This process is described in more detail below. A size-corrected grayscale snippet and bitonal snippet is then generated in step 50. Next, various bitonal image enhancements are performed in step 60, including image rotations, as will also be described below. The enhanced and rotated bitonal image is generated in step 70, and this enhanced bitonal image is then used for data capture, including capturing a date field (step 80) to generate, e.g., a date (90), capturing an address field (100) to generate an address (110), and capturing a tendered amount field (120) to generate an amount (120).

A method of identifying a size of the receipt and correcting a size of the image to match the size of the receipt (steps 40 and 50) is described herein. In a first step, the original bitonal snippet 30 is created, e.g., in accordance with the embodiments described in the '036 Application or in U.S. Pat. No. 7,778,457, entitled “Systems and Methods for Mobile Image Capture and Processing of Checks,” which is also incorporated herein by reference as if set forth in full, after which a preliminary rotation is performed to fix vertical text. Since a majority of receipts are “vertical” (that is, height is bigger than width), it usually results in rotating snippets with an incorrect width-to-height ratio. Thus, in certain embodiments, a more accurate detection and correction of the vertical text is performed using connected components algorithms.

Detection of upside-down text (step 60) can then be performed. If such text is detected, the image is rotated by 180 degrees. An accurate detection and correction of upside-down text can be done using Image Enhancement techniques, described for example in QuickFX API Interface Functions, Mitek Systems, Inc., which is incorporated herein by reference as if set forth in full. Using connected components analysis, all connected components (CCs) are found on image created above.

A histogram analysis can then be applied to detect the most frequent CC's widths. In case there is more than one candidate, additional logic is used to detect if the most frequent values could be considered to be the size of a lowercase or capital letter character.

The character width found above can then be compared to an expected width of a standard 3-inch receipt. If the width is approximately close to expected, the grayscale and bitonal images are recreated using known document widths of 3 inches, and if it is not close, the process skips to the next step. In the next step, the previously determined character width is compared to an expected width on an 11″×8.5″ page receipt. If the width is approximately close to expected, the grayscale and bitonal images are recreated using a known document width of 8.5″ and known height of 11″. Once the size of the receipt in the image is matched as closely as possible to the original size, the text and other characters are in better proportion for capturing using optical character recognition and other content recognition steps.

Bitonal image enhancements can include auto-rotation, noise removal and de-skew. Auto-rotation corrects image orientation from upside-down to right side up. In rare cases, the image is corrected from being 90 or 270 degrees rotated (so that text becomes vertical).

With respect to step 80, the date field on receipts largely has the following format: <MM>/<DD>/<YY>, as shown in FIG. 6B. There are less frequent formats like <MM>/<DD>/<YYYY> or with alpha-month. To capture the date, a combined Date field definition could be used, as described in the '036 application.

After the date field is found, the system can be configured to try to parse it into individual Month, Day and Year components. Each component can then be tested for possible ranges (no more than 31 days in a month, no more than 12 months etc.) and/or alpha-month is replaced by numeric value. The date results which do not pass such interpretation are suppressed.

The system can then be configured to search for the date field using Fuzzy Matching technique, such as those described in U.S. Pat. No. 8,379,914 (the '914 Patent), entitled “Systems and Methods for Mobile Image Capture and Remittance Processing,” which is incorporated herein by reference in its entirety as if set forth in full. Each found location of data can be assigned the format-based confidence, which reflects how close data in the found location matches expected format. For example, the format-based confidence for “07/28/08” is 1000 (of 1000 max); the confidence of “a7/28/08” is 875 because 1 of 8 non-punctuation characters (“a”) is inconsistent with the format. However, the format-based confidence of “07/2B/08” is higher (900-950) because ‘B’ is close to one of characters allowed by the format (‘8’).

The date with highest format-based confidence can then be returned in step 90.

With respect to step 100, United States address fields on receipts have a regular <Address> format, as illustrated in FIG. 6C. An address capture system described in the '036 application could be used to capture address from the receipts. In order to find the Address field and also to ensure its correctness, the system can be configured to first finds all address-candidates on the receipt, computes their confidences and returns the location with the highest confidence.

Usually, addresses are printed as left-, right- or center-justified text blocks isolated from the rest of document text by significant white margins. Based on this information, the system can detect potential address locations on a document by building text block structure. In one embodiment, this is done by applying text segmentation features available in most of OCR systems, such as Fine Reader Engine by ABBYY.

In most of US addresses, the bottommost line contains City/State/ZIP information. The system can utilize this knowledge by filtering out the text blocks found above that do not have enough alphas (to represent City and State), do not contain any valid state (which is usually abbreviated to 2 characters) and/or do not contain enough numbers in the end to represent Zip-code.

Once address candidates are selected using the processes described, the system can build the entire address block starting with City/State/ZIP at the bottom line and including 1-3 upper lines as potential Name and Street Address components. Since the exact format of the address is not often well-defined (it may have 1-4 lines, be with or without Recipient name, be with or without POBOX etc.), the system can be configured to make multiple address interpretation attempts to achieve satisfactory interpretation of the entire text block.

In order to compare OCR results with the data included into the Postal db, the Fuzzy Matching mechanism described above can be used. For example, if OCR reads “San Diego” as “San Dicgo” (‘c’ and ‘e’ are often misrecognized), Fuzzy Matching will produce matching confidence above 80% between the two, which is sufficient to achieve the correct interpretation of OCR result.

After the interpretation of the address block is achieved, the individual components can be corrected to become identical to those included into the Postal db. Optionally, the discrepancies between address printed on the receipt and its closest match in Postal db could be corrected by replacing invalid, obsolete or incomplete data as follows:
Correcting ZIP+4: For example, 92128-1284 could be replaced by 92128-1234 if the latter is a valid ZIP+4 additionally confirmed by either the street address or postal barcode.
Adding missing ZIP+4:For example, 92128 could be replaced by 92128-1234 if the latter is a valid ZIP+4 additionally confirmed by either the street address or postal barcode, see 2.8
Correcting invalid street suffixes, such as “Road” into “Street” if the “Street” suffix can be confirmed by Postal db while the “Road” one cannot.

The system can be configured to assign a confidence value on the scale from 0 to 1000 to each address it finds. Such confidences could be assigned overall for the entire address block or individually to each address component (Recipient Name, Street Number, Apartment Number, Street Name, POBOX Number, City, State and Zip). The larger values indicate that the system is quite sure that if found, read and interpreted the address correctly. The component-specific confidence reflects the number of corrections in this component required above. For example, if 1 out of 8 non-space characters was corrected the “CityName” address component (e.g. San Dicgo” v. “San Diego”), the confidence of 875 may be assigned (1000*7/8). The overall confidence is a weighted linear combination of individual component-specific confidences, where the weights are established experimentally.

With respect to step 120, detecting an amount on a receipt is compounded by the presence of multiple amounts on a receipt. For example, the receipt on FIGS. 1 and 2A/2B shows 5 different amount fields, see FIG. 6A. In one embodiment, an algorithm is used to determine which of the amounts is the tendered one. This algorithm can comprise various steps including a keyword-based search and a format-based search as described below.

The Tendered Amount field has a set of keyword phrases which allow to find (but not uniquely) the field's location on about 90% of receipts. In remaining 10%, the keyword cannot be found due to some combination of poor image quality, usage of small font, inverted text etc.

Some of frequent keyword phrases are:
Payment
Payment Due
Total
Total Due
Amount
Amount Tendered
Balance
Balance Due

Among these keywords the ones associated with charging credit cards is identified. For example, on FIG. 7 shows keywords 401 “Payment” and 403 “Amount Tendered”.

The system can be configured to search for keywords in the OCR result using Fuzzy Matching technique. For example, if OCR result contains “Bajance Due” then the “Balance Due” keyword will be found with confidence of 900 (out of 1000 max) because 9 out of 10 non-space characters are the same as in the “Balance Due”.

The Tendered Amount field has so-called “DollarAmount” format, which is one of pre-defined data formats explained in the '914 Patent. This data format can be used by the system instead of or in combination with keyword-based search to further narrow down the set of candidates for the field.

Example on FIG. 4 shows a receipt with the Tendered Amount data 402 adjacent to keyword 401 and another (identical) data 404 adjacent to keyword 403. You can also see other four instances of data with “DollarAmount” format in 404.

The system can be configured to search for data below or to the right of each keyword found above, e.g., using the Fuzzy Matching technique of the '914 Patent. Each found location of data is assigned the format-based confidence, which reflects how close data in the found location matches expected format (in this case, “DollarAmount”). For example, the format-based confidence for “$94.00” is 1000 (of 1000 max); the confidence of “$94.A0” is 800 because 1 of 5 non-punctuation characters (“A”) is inconsistent with the format; however, the format-based confidence of “$9S.00” is higher (900-950) because ‘S’ is close to one of characters allowed by the format (‘5’).

Using connected components analysis, all connected components (CCs) are found on the image. The system computes average font size on image by building a histogram of individual character's heights over all CCs that are found. The system can then compute the average character thickness on image by building a histogram of individual character's thicknesses over all CCs found. For each data location found, the system can compute the combined score (CS) using a linear combination of the following values:
Keyword confidence, see 4.1 (with a positive weight W1)
Format-based confidence, see 4.2 (with a positive weight W2)
Data height, relative to the average size 4.4 (with a positive weight W3). The taller data is more likely to be the Tendered Amount
Thickness, relative to the average thickness 4.5 (with a positive weight W4). The data printed in bolder fonts is more likely to be the Tendered Amount
Vertical coordinate, counting from the top (with a positive weight W5). The locations closer to the bottom are more likely to be the Tendered Amount
The amount value (with a positive weight W6). The larger values are more likely to be the Tendered Amount
1, if the amount is associated with keywords related to charging a credit card (see 4.1), or equal to some of such amounts (with a positive weight W7). Otherwise, 0
1, if the amount is equal to another one NOT associated with keywords related to charging a credit card (with a positive weight W8, W8<W7). Otherwise, 0

The weights W1-W8 are established experimentally.

The candidate with the highest CS computed can then be output. Once the data from all of the receipt fields is obtained, the content may be organized into a file or populated into specific software which tracks the specific fields for financial or other purposes. In one embodiment, a user may be provided with a user interface which lists the fields on a receipt and populates the extracted content from the receipt in a window next to each field.

It will be understood that the term system in the preceding paragraph, and throughout this description unless otherwise specified, refers to the software, hardware, and component devices required to carry out the methods described herein. This will often include a mobile device that includes an image capture systems and software that can perform at least some of the steps described herein. In certain embodiments, the system may also include server side hardware and software configured to perform certain steps described herein.

FIG. 8 is one embodiment of a network upon which the methods described herein may be implemented. As can be seen, the network connects a capture device 702, such as a mobile phone, tablet, etc., with a server 708. The capture device 702 can include an image 704 that is captured and, e.g., at least partially processed as described above and transmitted over network 706 to server 708. In certain embodiments, all of the processing can occur on device 702 and only data about the receipt in image 704 can be transmitted to server 708.

FIG. 9 is an embodiment of a computer, processor and memory upon which a mobile device, server or other computing device may be implemented to carry out the methods described herein. In the example, of FIG. 9, a network interface module 906 can be configured to receive image 704 over network 706. Image 704 can be stored in memory 908. A processor 904 can be configured to control at least some of the operations of server 708 and can, e.g., be configured to perform at least some of the steps described herein, e.g., by implementing software stored in memory 908. For example, a receipt recognition module 910 can be stored in memory 908 and configured to cause processor 904 to perform at least some of the steps described above. In other embodiments, module 906 can simply receive information about the receipt in image 704.

Power supply module 902 can be configured to supply power to the components of server 708.

While various embodiments have been described above, it should be understood that they have been presented by way of example only, and not of limitation. The breadth and scope should not be limited by any of the above-described exemplary embodiments. Where this document refers to technologies that would be apparent or known to one of ordinary skill in the art, such technologies encompass those apparent or known to the skilled artisan now or at any time in the future. In addition, the described embodiments are not restricted to the illustrated example architectures or configurations, but the desired features can be implemented using a variety of alternative architectures and configurations. As will become apparent to one of ordinary skill in the art after reading this document, the illustrated embodiments and their various alternatives can be implemented without confinement to the illustrated example. One of ordinary skill in the art would also understand how alternative functional, logical or physical partitioning and configurations could be utilized to implement the desired features of the described embodiments.

Furthermore, although items, elements or components may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A computer readable medium containing instructions which, when executed by a computer, perform a process comprising:
receiving an image of a receipt;
preprocessing the image of the receipt in preparation for data extraction;
identifying the size of the receipt based on the image of the receipt;
resizing the image of the receipt when it is determined based on the size identification that resizing is necessary;
identifying at least one field on the receipt;
extracting a set of data from the at least one identified field; and
displaying the extracted set of data to a user.

2. The computer readable medium of claim 1, wherein the preprocessing comprises creating grayscale snippets of the receipt.

3. The computer readable medium of claim 2, wherein the snippets are high contrast snippets.

4. The computer readable medium of claim 2, wherein the snippets are low contrast snippets.

5. The computer readable medium of claim 1, wherein the preprocessing comprises creating bitonal snippets of the receipt.

6. The computer readable medium of claim 1, wherein identifying the size of the receipt comprises detecting vertical text within the image.

7. The computer readable medium of claim 6, wherein identifying the size of the receipt further comprises, when vertical text is detected, then rotating the image by 90 degrees.

8. The computer readable medium of claim 6, wherein connected components analysis is used to identify the size of the receipt and rotate the receipt if necessary.

9. The computer readable medium of claim 1, wherein the process further comprises detecting upside-down text in the image of the receipt.

10. The computer readable medium of claim 9, wherein the image is rotated by 180 degrees, when upside down text is detected.

11. The computer readable medium of claim 8, wherein connected components analysis is used to detect upside sown text and rotate the image if necessary.

12. The computer readable medium of claim 1, wherein identifying the size of the receipt and resizing the image of the receipt is performed using connected components analysis in which all the connected components (CCs) are found in image.

13. The computer readable medium of claim 12, wherein the process further comprises performing a histogram analysis on CCs to detect the most frequent CC's width.

14. The computer readable medium of claim 13, wherein the process further comprises, using additional logic to detect if two most frequent values are candidates for the size of regular and capitalize characters, when the histogram analysis produces more than one candidate.

15. The computer readable medium of claim 12, wherein a character width found in the connected components analysis is compared to expected width on 3″ receipts, and wherein if the width is determined to be approximately close to the expected width, then rescaling a grayscale or bitonal snippet of the image of the receipt using a known document width of 3″.

16. The computer readable medium of claim 12, wherein a character width found in the connected component analysis is compared to expected width on 11″×8.5″ receipts, and wherein if the width is approximately close to the expected width, then rescaling a grayscale or bitonal snippet of the image of the receipt using a known document width of 8.5″ and known height of 11″.

17. The computer readable medium of claim 1, wherein the at least on field on the receipt comprises at least one of: a date, an address, an amount.

18. The computer readable medium of claim 17, wherein the date is identified and extracted by identifying month, day and year fields, parsing the data and determining whether the parsed data is an acceptable date.

19. The computer readable medium of claim 17, wherein the date is identified and extracted by identifying potential date fields, parsing the data, and assigning a format-based confidence value to each potential field based on the parsed data.

20. The computer readable medium of claim 17, wherein identifying the amount comprises performing at least one of keyword-based search and format-based search.
